(19) United States
(12) Patent Application Publication
(10) Pub. No.: US 2024/0420902 A1
(43) Pub. Date: Dec. 19, 2024

(54) MULTIPLE-OPERATION INPUT DEVICE

(71) Applicant: ALPS ALPINE CO., LTD., Tokyo (JP)

(72) Inventor: Takashi SATO, Gwangju (KR)

(21) Appl. No.: 18/819,362

(22) Filed: Aug. 29, 2024

Related U.S. Application Data
(63) Continuation of application No. PCT/JP2023/005014, filed on Feb. 14, 2023.

(30) Foreign Application Priority Data
Mar. 30, 2022 (JP) 2022-057381

(51) Int. Cl. H01H 13/14; G06F 3/02; G06F 3/0354; G06F 3/0362; H01H 13/04; H01H 19/14

(52) U.S. Cl. CPC H01H 13/14; G06F 3/02; G06F 3/03548; G06F 3/0362; H01H 13/04; H01H 19/14

(57) ABSTRACT

A multiple-operation input device includes: an operation body configured to rotate around a predetermined axis and to press in a first direction orthogonal to the axis; a shaft provided to project from the operation body on the axis and configured to rotate around the axis integrally with the operation body; a moving body configured to axially support the shaft and to reciprocatingly move in the first direction together with the shaft; a push switch configured to be pressed by the moving body and to switch to a switched-on state upon pressing of the operation body; a click-feeling cam configured to integrally rotate with the shaft; a slider configured to reciprocatingly move in the first direction and to include a tip contacting an outer periphery of the click-feeling cam; an elastic member configured to bias the slider; a casing; and a rotation restrictor configured to restrict rotation of the click-feeling cam.

### CROSS-REFERENCE TO RELATED APPLICATIONS

This application is a continuation application of International Application No. PCT/JP2023/005014, filed on Feb. 14, 2023, and designated the U.S., which is based upon and claims priority to Japanese Patent Application No. 2022-057381 filed on Mar. 30, 2022, the entire contents of which are incorporated herein by reference.

### BACKGROUND

### 1. Field of the Invention

The present disclosure relates to a multiple-operation input device.

### 2. Description of the Related Art

Japanese Laid-Open Patent Application No. 2019-145274 discloses a technique for restricting rotation of an operation body by engaging a rotary assembly with a stopper when pressing is performed in a multiple-operation input device capable of rotating and pressing by the operation body.

### SUMMARY

A multiple-operation input device according to one embodiment includes: an operation body configured to rotate around an axis, that is predetermined, and to press in a first direction orthogonal to the axis; a shaft configured to project from the operation body on the axis and to rotate around the axis integrally with the operation body; a moving body configured to axially support the shaft and to reciprocatingly move in the first direction together with the shaft; a push switch configured to be pressed by the moving body and to switch to a switched-on state upon pressing of the operation body; a click-feeling cam configured to integrally rotate with the shaft, the click-feeling cam being provided in an outer periphery where a peak and a trough having different heights in a radial direction are alternately arranged in a circumferential direction; a slider configured to reciprocatingly move in the first direction and to include a tip contacting an outer periphery of the click-feeling cam; an elastic member configured to bias the slider toward the click-feeling cam; a casing; and a rotation restrictor configured to restrict rotation of the click-feeling cam via the slider upon pressing of the operation body.

### BRIEF DESCRIPTION OF THE DRAWINGS

FIG. 1 is an external perspective view of a multiple-operation input device according to one embodiment of the present disclosure;

FIG. 2 is a cross-sectional view taken in an XZ plane of the multiple-operation input device according to one embodiment;

FIG. 3 is a cross-sectional view taken in a YZ plane of the multiple-operation input device according to one embodiment;

FIG. 4 is a cross-sectional view taken in the XZ plane of the multiple-operation input device according to a first example of one embodiment;

FIG. 5 is a cross-sectional view taken in the XZ plane of the multiple-operation input device according to a second example of one embodiment; and

FIG. 6 is a cross-sectional view taken in the XZ plane of the multiple-operation input device according to a third example of one embodiment.

### DETAILED DESCRIPTION OF THE PRESENT DISCLOSURE

According to the technique of Japanese Laid-Open Patent Application No. 2019-145274, when a strong rotation force is applied while a rotary assembly is engaged with the stopper, the rotary assembly or the stopper may be damaged.

Hereinafter, one embodiment of the present disclosure will be described with reference to the drawings.

### (Configuration of a Multiple-Operation Input Device 100)

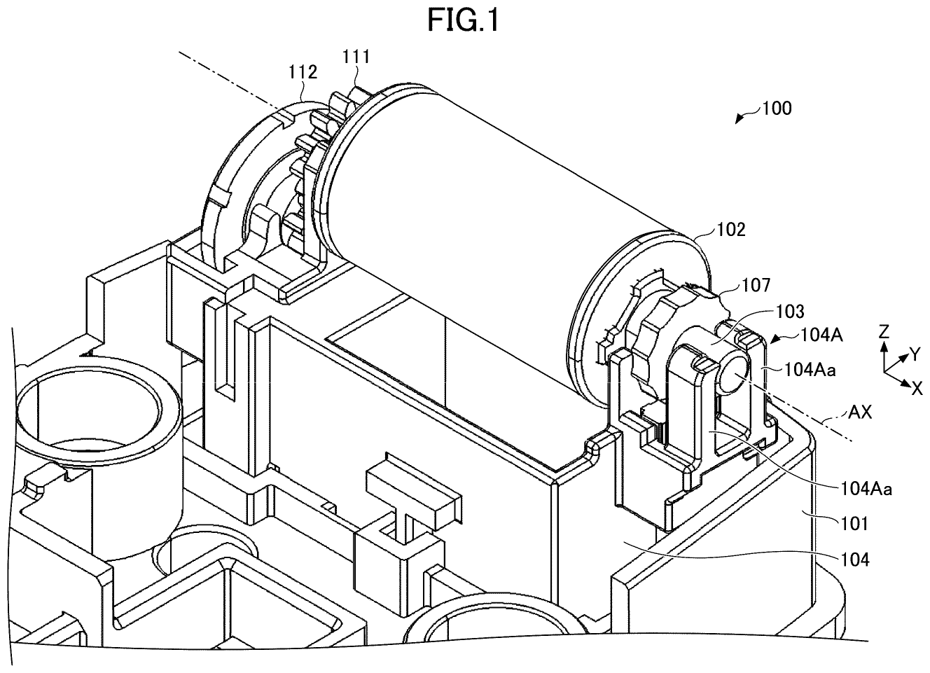

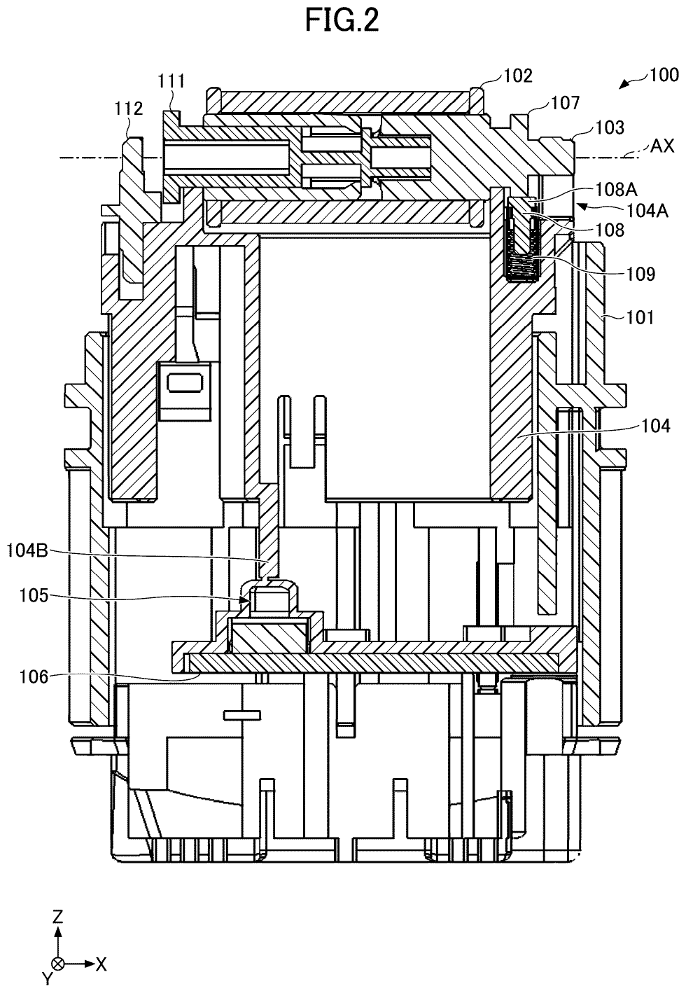

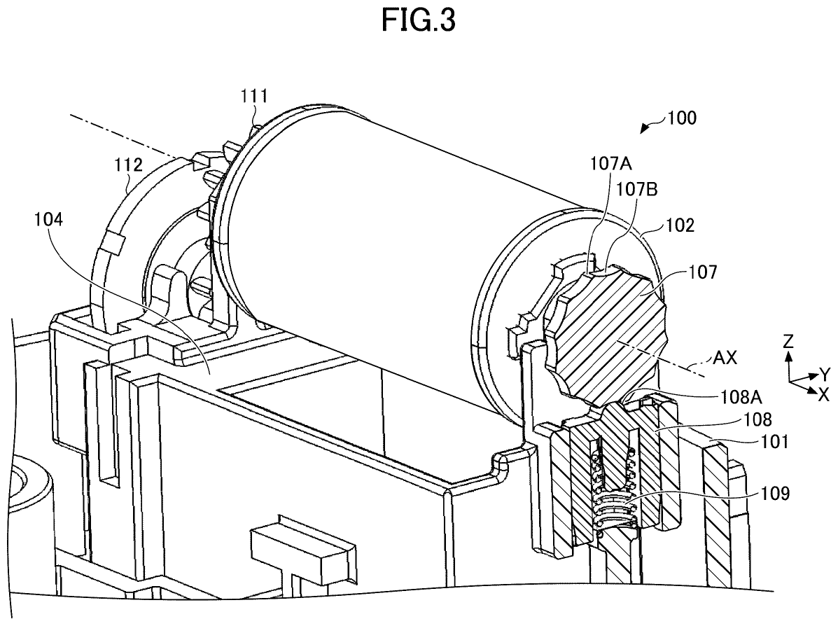

FIG. 1 is an external perspective view of a multiple-operation input device 100 according to one embodiment. FIG. 2 is a cross-sectional view taken in an XZ plane passing through a center of an operation body 102 of the multiple-operation input device 100 according to the embodiment. FIG. 3 is a cross-sectional view taken in a YZ plane passing through a center of a click-feeling cam 107 of the multiple-operation input device 100 according to the embodiment.

In the following description, for convenience, an X-axis direction is assumed to be a lateral direction, a Y-axis direction is assumed to be a front-rear direction, and a Z-axis direction is assumed to be a vertical direction (an example of a “first direction”), where a positive direction of the X-axis is a right direction, a positive direction of the Y-axis is a front direction, and a positive direction of the Z-axis is an upper direction. These directions indicate the relative positional relationship within a device, and are not intended to limit an installation direction or an operation direction of the device. All components having the same relative positional relationship within a device, even those having different installation directions or operation directions, are included in the scope of the present disclosure.

The multiple-operation input device 100 illustrated in FIGS. 1 to 3 is a device capable of rotating and pressing the operation body 102.

As illustrated in FIGS. 1 to 3, the multiple-operation input device 100 includes a casing 101, the operation body 102, a shaft 103, a moving body 104, a push switch 105, a substrate 106, the click-feeling cam 107, a slider 108, an elastic member 109, a gear 111, and a rotation detector 112.

The casing 101 is a resin-made, container-like member for housing and supporting components.

The operation body 102 is a resin-made member having a cylindrical shape extending in a lateral direction (in the X-axis direction) along an AX-axis, and located on an upper side (in a Z-axis positive direction) of the casing 101. The operation body 102 is arranged so as to be rotatable around the AX-axis and pressed in a vertical direction perpendicular to the AX-axis (one example of the “first direction”).

The shaft 103 is provided so as to penetrate through the operation body 102 in the lateral direction (X-axis direction) along the AX-axis on the upper side (on a Z-axis positive side) of the casing 101. A part of the right side (on an X-axis positive side) of the shaft 103 projects from an end surface of the operation body 102. The shaft 103 can rotate around the AX-axis integrally with the operation body 102.

The moving body 104 is a resin member provided inside the casing 101 and below (on a Z-axis negative side of) the operation body 102. The moving body 104 axially supports the shaft 103 and is provided so as to reciprocatingly move in the vertical direction (Z-axis direction) together with the shaft 103.

The moving body 104 includes a support 104A at an upper end (on the Z-axis positive side) and at a right end (on the X-axis positive side) thereof. The support 104A includes a pair of wall portions 104Aa (see FIG. 1) in the front-rear direction (Y-axis direction). The pair of wall portions 104Aa extend in the vertical direction (Z-axis direction) with a fixed interval (interval slightly greater than the outer diameter of the shaft 103) from each other in the front-rear direction (Y-axis direction). The shaft 103 is disposed between the pair of wall portions 104Aa. Thus, the moving body 104 supports the shaft 103 rotatably around the AX-axis. The upper ends of the pair of wall portions 104Aa are formed in an R-shape along the outer shape of the shaft 103, and the width in the front-rear direction is formed narrower than the outer diameter of the shaft 103, so that the shaft 103 can be prevented from being pulled out in an upward direction.

When the operation body 102 is pressed, the moving body 104 moves downward (in the Z-axis negative direction) together with the operation body 102 and the shaft 103. As illustrated in FIG. 2, a presser 104B is provided at a lower end of the moving body 104.

The push switch 105 is provided on the substrate 106 and below the presser 104B of the moving body 104, and faces the presser 104B. When the operation body 102 is pressed, the push switch 105 is pressed by the presser 104B of the moving body 104 to switch to an ON state.

The substrate 106 is a resin plate member provided in a horizontal posture inside the casing 101 and below the moving body 104. The push switch 105 is mounted on the substrate 106 and below the presser 104B of the moving body 104.

The click-feeling cam 107 is provided integrally with the shaft 103 on the upper side of the casing 101 (on the Z-axis positive side), on the AX-axis, and on the right side of the moving body 104 (on a side of the X-axis positive side) so as to be rotatable about the AX-axis. The click-feeling cam 107 is provided with a peak 107A and a trough 107B having different heights in the radial direction, which are arranged alternately in the circumferential direction.

The slider 108 is provided on the upper side of the casing 101 (on the Z-axis positive side) and below the click-feeling cam 107 (on the Z-axis negative side) so as to be capable of reciprocating in the vertical direction (the Z-direction). The slider 108 includes a tip 108A at an upper end thereof (end portion on the Z-axis positive side), which contacts an outer periphery of the click-feeling cam 107 in the first direction.

The elastic member 109 is provided below (on the Z-axis negative side of) the slider 108 so as to be elastically deformable in the vertical direction, and biases the slider 108 toward the click-feeling cam 107. Although a coil spring is used as an example of the elastic member 109 in the present embodiment, the elastic member 109 is not limited to the coil spring.

The gear 111 is provided on the upper side (on the Z-axis positive side) of the casing 101 and on a left side on the AX-axis (on an X-axis negative side) of the operation body 102. The gear 111 is rotatable around the AX-axis integrally with the operation body 102.

The rotation detector 112 is provided on the upper side (on the Z-axis positive side) of the casing 101 and on the left side (on the X-axis negative side) of the gear 111. When the operation body 102 is rotated, the rotation detector 112 detects the rotation of the operation body 102 by a rotation force of the operation body 102 being transmitted via the gear 111. The rotation detector 112 is held by the moving body 104 so as to detect rotation together with a sensor (such as an optical sensor, magnetic sensor, etc.) not illustrated in the figures.

In the multiple-operation input device 100 configured as described above, when the operation body 102 is rotated, the operation body 102, the shaft 103, the click-feeling cam 107, and the gear 111 are integrally rotated around the AX-axis. At this time, the rotation force of the operation body 102 is transmitted to the rotation detector 112 via the gear 111, and thus the rotation of the operation body 102 is detected by the rotation detector 112.

At this time, the multiple-operation input device 100 imparts a click feeling to the rotation of the operation body 102 by allowing the tip 108A of the slider 108 biased by the elastic member 109 to slide on the outer periphery of the click-feeling cam 107, and by pushing and compressing the elastic member 109 while moving over the peak 107A and a trough 107B, the peak 107A being a portion with high height in the radial direction of the click-feeling cam 107, and a trough 107B being a portion with low height in the radial direction adjacent to the peak 107A of the click-feeling cam 107.

In the multiple-operation input device 100, when the operation body 102 is pressed, the moving body 104 supporting the shaft 103 fixed to the operation body 102 moves downward (in the Z-axis negative direction) within the casing 101 along a guide portion (not illustrated) provided in the casing 101 while maintaining the horizontal state. At this time, the presser 104B of the moving body 104 presses the push switch 105 to switch the push switch 105 to the ON state. Thus, the pressing of the operation body 102 is detected.

### EXAMPLES

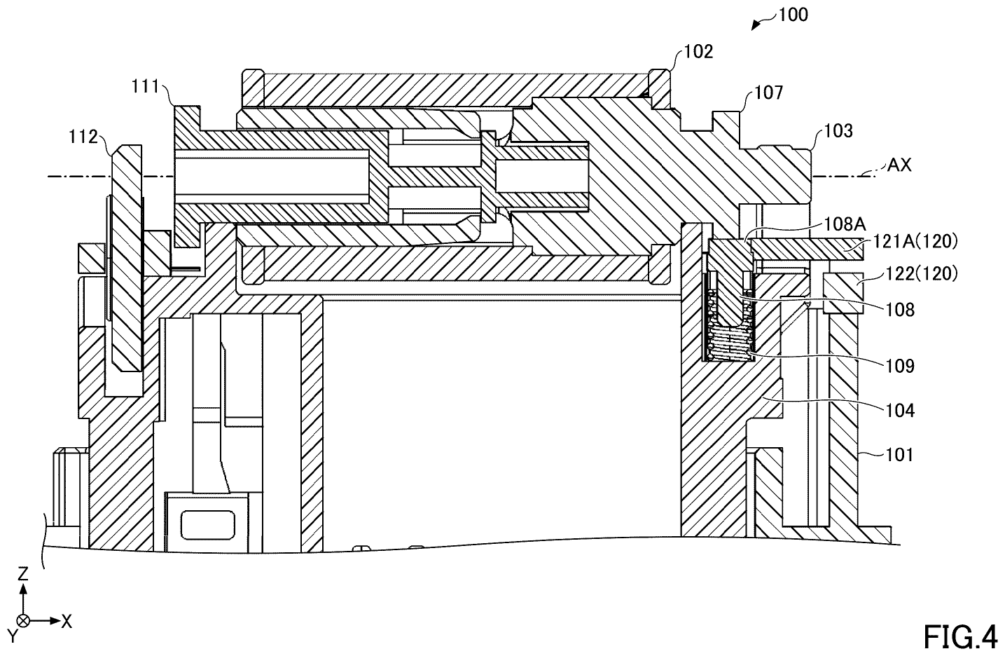

First to third examples of the multiple-operation input device 100 will be described in the following with reference to FIGS. 4 to 6. The multiple-operation input device 100 according to the first to third examples includes a rotation restrictor 120. The rotation restrictor 120 restricts rotation of the click-feeling cam 107 via the slider 108 when the operation body 102 is pressed.

### First Example

FIG. 4 is a cross-sectional view taken in the XZ plane passing through the center of the click-feeling cam 107 of the multiple-operation input device 100 according to the first example of one embodiment.

As illustrated in FIG. 4, the rotation restrictor 120 according to the first example includes a first contact portion 121A provided so as to project in the right direction (X-axis positive direction) from a side surface of the slider 108, and a first stopper 122 provided below (on the Z-axis negative side of) the first contact portion 121A at a predetermined distance apart from the slider 108 and facing the slider 108.

In the example as illustrated in FIG. 4, the first stopper 122 is provided integrally with the casing 101, but the first stopper 122 may be a component provided separately from the casing 101.

Further, since the first contact portion 121A is made of resin and has a longitudinal shape in the lateral direction (X-axis direction), and only one end in the lateral direction (X-axis direction) is fixed, the first contact portion 121A can elastically deform in the first direction (vertical direction) when an external force is applied.

In the multiple-operation input device 100 according to the first example, when the operation body 102 is rotated at an initial height position, the slider 108 can freely reciprocate in the vertical direction (Z-axis direction), so that the tip 108A of the slider 108 can ride over the peak 107A of the click-feeling cam 107. Therefore, when the operation body 102 is rotated, the multiple-operation input device 100 according to the first example can rotate the operation body 102 while imparting a click feeling to the rotation of the operation body 102.

On the other hand, in the multiple-operation input device 100 according to the first example, when the operation body 102 is pressed, the slider 108 held by the moving body 104 moves downward (Z-axis negative direction) together with the moving body 104.

In the multiple-operation input device 100 according to the first example, when the slider 108 moves downward (Z-axis negative direction) by a predetermined amount, a lower surface of the first contact portion 121A provided on the slider 108 contacts on an upper surface of the first stopper 122, thereby restricting the downward movement of the slider 108 relative to the moving body 104 (Z-axis negative direction).

Thus, the multiple-operation input device 100 according to the first example can prevent the tip 108A of the slider 108 from riding over the peak 107A of the click-feeling cam 107, that is, can restrict rotation of the click-feeling cam 107.

Therefore, the multiple-operation input device 100 according to the first example can reduce undesired rotation of the operation body 102 when the operation body 102 is pressed.

Further, in the multiple-operation input device 100 according to the first example, when the push switch 105 is not yet turned on at the time when the first contact portion 121A that is provided on the slider 108 contacts the first stopper 122 due to variations in component dimensions or the like, upon application of further pressure to the operation body 102 from this state, the first contact portion 121A provided on the slider 108 elastically deforms upward (in the first direction), and the moving body 104 moves further downward, so that the push switch 105 can be surely pressed by the presser 104B of the moving body 104.

### Second Example

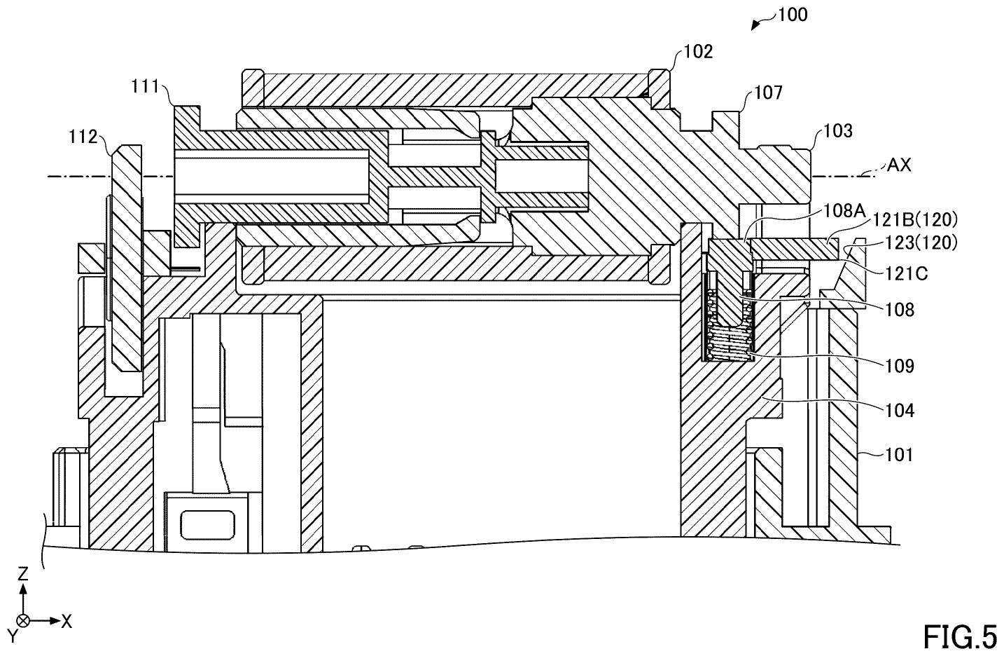

FIG. 5 is a cross-sectional view taken in the XZ plane passing through the center of the click-feeling cam 107 of the multiple-operation input device 100 according to the second example of one embodiment.

As illustrated in FIG. 5, the rotation restrictor 120 according to the second example includes a second contact portion 121B provided so as to project in the right direction (X-axis positive direction) from the side surface of the slider 108, and a tapered surface 123 provided below (in the Z-axis negative direction) and to the right (in the X-axis positive direction) of the second contact portion 121B. The tapered surface 123 is a tapered surface facing upward (Z-axis positive direction) and leftward (X-axis negative direction), that is, a tapered surface facing a lower right corner portion 121C of the second contact portion 121B, and is inclined in a direction orthogonal to the first direction (Z-axis direction).

In the example as illustrated in FIG. 5, the tapered surface 123 is provided integrally with the casing 101, but the tapered surface 123 may be a component provided separately from the casing 101.

Further, since the second contact portion 121B has a longitudinal shape in the lateral direction (X-axis direction) and only one end in the lateral direction (X-axis direction) is fixed, the second contact portion 121B can be bent in the vertical direction when an external force is applied.

In the multiple-operation input device 100 according to the second example, since the second contact portion 121B and the tapered surface 123 are separated from each other when the operation body 102 is rotated at the initial height position, the slider 108 can freely reciprocate in the vertical direction (Z-axis direction), and the tip 108A of the slider 108 can ride over the peak 107A of the click-feeling cam 107. Therefore, in the multiple-operation input device 100 according to the second example, when the operation body 102 is rotated, the operation body 102 can be rotated while imparting a click feeling to the rotation of the operation body 102.

On the other hand, in the multiple-operation input device 100 according to the second example, when the operation body 102 is pressed, the slider 108 held by the moving body 104 moves downward (in the Z-axis negative direction) together with the moving body 104.

In the multiple-operation input device 100 according to the second example, when the slider 108 moves downward (in the Z-axis negative direction) by a predetermined amount, the lower right corner portion 121C of the second contact portion 121B provided in the slider 108 contacts the tapered surface 123, so that a leftward (X-axis negative direction) force is applied to the second contact portion 121B. By this force, the slider 108 is pressed leftward (in the X-axis negative direction), thereby increasing the slide load when moving in the vertical direction (in the Z-axis negative direction), and making it difficult to move in the vertical direction (in the Z-axis negative direction).

Thus, in the multiple-operation input device 100 according to the second example, it is possible to make it difficult for the tip 108A of the slider 108 to ride over the peak 107A of the click-feeling cam 107, that is, the rotation of the click-feeling cam 107 can be restricted.

Therefore, in the multiple-operation input device 100 according to the second example, undesired rotation of the operation body 102 when the operation body 102 is pressed can be reduced.

In the multiple-operation input device 100 according to the second example, the greater the downward (in the Z-axis negative direction) movement amount of the slider 108, the greater the leftward (in the X-axis negative direction) force applied to the slider 108 via the second contact portion 121B.

Therefore, in the multiple-operation input device 100 according to the second example, the greater the amount of downward movement of the slider 108 (in the Z-axis negative direction), the more difficult it is for the tip 108A of the slider 108 to ride over the peak 107A of the click-feeling cam 107, that is, rotation of the click-feeling cam 107 can be restricted.

Further, in the multiple-operation input device 100 according to the second example, the second contact portion 121B provided on the slider 108 is made of resin. When the slide load applied to the slider 108 becomes too high upon moving downward due to strong contact against the tapered surface 123 resulted by variations in component dimensions or the like, downward movement of the slider 108 becomes difficult. In such a state, when further pressure is applied to the operation body 102, the second contact portion 121B provided on the slider 108 elastically deforms upward (in the first direction), and the moving body 104 moves further downward, and thus the push switch 105 can be surely pressed by the presser 104B of the moving body 104.

The “tapered surface” may be provided on the slider 108, and the “second contact portion” may be provided on the casing 101. The corner portion 121C need not necessarily be perpendicular, and may be formed into an R shape or a C shape.

### Third Example

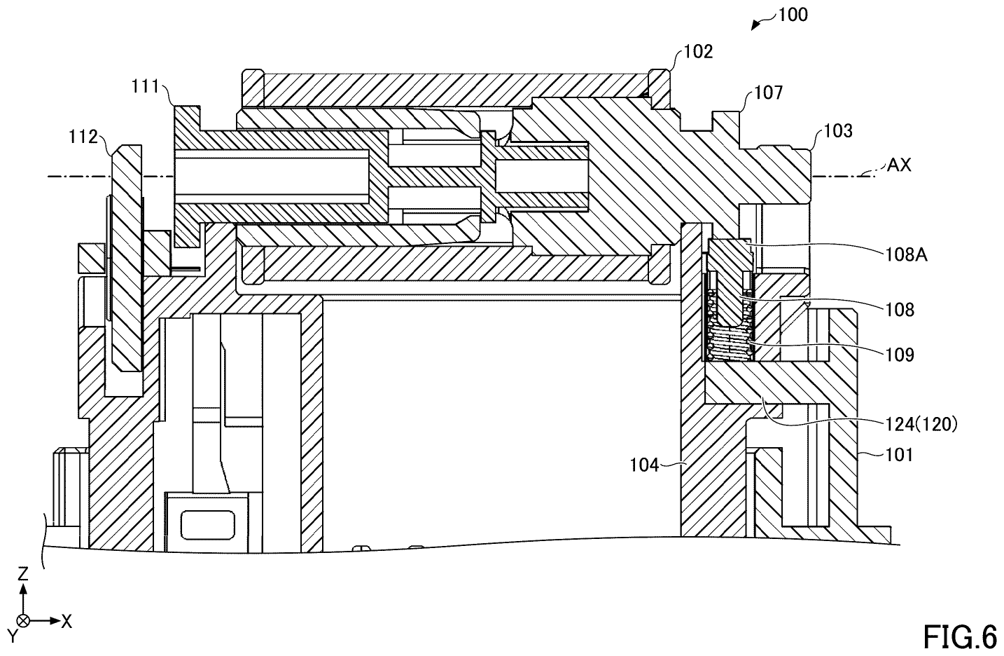

FIG. 6 is a cross-sectional view taken in the XZ plane passing through the center of the click-feeling cam 107 of the multiple-operation input device 100 according to the third example of one embodiment.

As illustrated in FIG. 6, in the casing 101, the rotation restrictor 120 according to the third example includes a second stopper 124 provided below (on the Z-axis negative side of) a lower end of the elastic member 109 and is supported so as to face the lower end of the elastic member 109.

In the example as illustrated in FIG. 6, the second stopper 124 is provided integrally with the casing 101, but the second stopper 124 may be a component provided separately from the casing 101.

Further, the second stopper 124 has a longitudinal shape in the lateral direction (X-axis direction), and only one end in the lateral direction (X-axis direction) is fixed to the casing 101 so as not to interfere with the moving body 104, so that when the operation body 102 is pressed, the second stopper 124 does not contact the moving body 104.

In the multiple-operation input device 100 according to the third example, when the operation body 102 is rotated at the initial height position, since the elastic member 109 is not pressed by the second stopper 124, the biasing force in the first direction applied to the slider 108 from the elastic member 109 is the smallest, and therefore the tip 108A of the slider 108 can easily ride over the peak 107A of the click-feeling cam 107. Therefore, when the operation body 102 is rotated, the multiple-operation input device 100 according to the third example can rotate the operation body 102 while imparting a click feeling to the rotation of the operation body 102.

On the other hand, in the multiple-operation input device 100 according to the third example, when the operation body 102 is pressed, a position of the lower end of the elastic member 109 is fixed by the second stopper 124, and the elastic member 109 is gradually pressed and contracted, so that the biasing force applied from the elastic member 109 to the slider 108 in the first direction gradually increases.

Thus, in the multiple-operation input device 100 according to the third example, the tip 108A of the slider 108 can be made difficult to ride over the peak 107A of the click-feeling cam 107, that is, rotation of the click-feeling cam 107 can be restricted.

Therefore, in the multiple-operation input device 100 according to the third example, undesired rotation of the operation body 102 when the operation body 102 is pressed can be reduced.

In the multiple-operation input device 100 according to the third example, the greater the downward (Z-axis negative direction) movement amount of the slider 108, the greater the amount by which the elastic member 109 is pressed and contracted by the second stopper 124, and the greater the biasing force applied from the elastic member 109 to the slider 108.

Therefore, in the multiple-operation input device 100 according to the third example, the greater the downward (Z-axis negative direction) movement amount of the slider 108, the greater the tip 108A of the slider 108 can be made difficult to ride over the peak 107A of the click-feeling cam 107, that is, rotation of the click-feeling cam 107 can be restricted.

Furthermore, in the multiple-operation input device 100 according to the third example, a coil contact length of the elastic member 109 at the time of compression thereof is set so that when the elastic member 109 is pressed and contracted by the second stopper 124 and further pressure is applied to the operation body 102, the moving body 104 moves further downward and the push switch 105 can be pressed by the presser 104B of the moving body 104.

Since the multiple-operation input device 100 according to the third example adopts a configuration in which rotation of the operation body 102 is restricted by strongly pressing the slider 108 against the click-feeling cam 107, the force can be released when an excessive force is applied, so that the parts are less likely to be damaged than when the parts are completely engaged together to restrict the rotation. Furthermore, even when the click-feeling cam 107 is damaged, the gear 111 and the rotation detector 112 are not affected, so that the detection of the rotation of the operation body 102 by the rotation detector 112 can be continued.

According to the multiple-operation input device according to one embodiment, undesired rotation of the operation body when the operation body is pressed can be reduced so as not to damage components even when a strong rotation force is applied.

Although one embodiment of the present invention has been described in detail above, the present invention is not limited to the embodiment, and can be modified or changed in various ways within the scope of the gist of the present invention recited in the claims.

For example, two or more from among: the rotation restrictor 120 according to the first example; the rotation restrictor 120 according to the second example; and the rotation restrictor 120 according to the third example may be selectively combined for use.

What is claimed is:

1. A multiple-operation input device, comprising:
an operation body configured to rotate around a predetermined axis and to press in a first direction orthogonal to the axis;
a shaft provided to project from the operation body on the axis and configured to rotate around the axis integrally with the operation body;
a moving body configured to axially support the shaft and to reciprocatingly move in the first direction together with the shaft;
a push switch configured to be pressed by the moving body and to switch to a switched-on state upon pressing of the operation body;
a click-feeling cam configured to integrally rotate with the shaft, the click-feeling cam being provided in an outer periphery where a peak and a trough having different heights in a radial direction are alternately arranged in a circumferential direction;
a slider configured to reciprocatingly move in the first direction and to include a tip contacting an outer periphery of the click-feeling cam;
an elastic member configured to bias the slider toward the click-feeling cam;
a casing; and
a rotation restrictor configured to restrict rotation of the click-feeling cam via the slider upon pressing of the operation body.

2. The multiple-operation input device according to claim 1, wherein
the rotation restrictor includes
a first contact portion provided in the slider, and
a first stopper included in the casing and, in the first direction, configured to face the first contact portion of the slider, and
the rotation restrictor is configured to
restrict movement of the slider toward the first direction in response to the first contact portion of the slider contacting the first stopper upon pressing of the operation body, and
restrict rotation of the click-feeling cam by preventing the tip of the slider from riding over the peak.

3. The multiple-operation input device according to claim 1, wherein
the rotation restrictor includes
a second contact portion included in either of the casing or the slider, and
a tapered surface included in another of the casing or the slider, and configured to incline in a direction orthogonal to the first direction, and
the rotation restrictor is configured to
increase a slide load upon moving of the slider in the first direction by contacting the second contact portion with the tapered surface, and
restrict rotation of the click-feeling cam by preventing the tip of the slider from riding over the peak of the click-feeling cam.

4. The multiple-operation input device according to claim 2, wherein
the rotation restrictor includes
a second contact portion included in either of the casing or the slider, and
a tapered surface included in another of the casing or the slider, and configured to incline in a direction orthogonal to the first direction, and
the rotation restrictor is configured to
increase a slide load upon moving of the slider in the first direction by contacting the second contact portion with the tapered surface, and
restrict rotation of the click-feeling cam by preventing the tip of the slider from riding over the peak of the click-feeling cam.

5. The multiple-operation input device according to claim 1, wherein
the rotation restrictor includes a second stopper included in a casing and configured to support an end of the elastic member, and
the rotation restrictor is configured to
increase a biasing force in the first direction of the slider by pressing and contracting the elastic member upon pressing of the operation body, and
restrict rotation of the click-feeling cam by preventing the tip of the slider from riding over the peak of the click-feeling cam.

6. The multiple-operation input device according to claim 2, wherein
the rotation restrictor includes a second stopper included in a casing and configured to support an end of the elastic member, and
the rotation restrictor is configured to
increase a biasing force in the first direction of the slider by pressing and contracting the elastic member upon pressing of the operation body, and
restrict rotation of the click-feeling cam by preventing the tip of the slider from riding over the peak of the click-feeling cam.

7. The multiple-operation input device according to claim 3, wherein
the rotation restrictor includes a second stopper included in a casing and configured to support an end of the elastic member, and
the rotation restrictor is configured to
increase a biasing force in the first direction of the slider by pressing and contracting the elastic member upon pressing of the operation body, and
restrict rotation of the click-feeling cam by preventing the tip of the slider from riding over the peak of the click-feeling cam.

8. The multiple-operation input device according to claim 2, wherein
the first contact portion is configured to elastically deform in the first direction in conjunction with the pressing in a contact state.

9. The multiple-operation input device according to claim 3, wherein
the second contact portion is configured to elastically deform in the first direction in conjunction with the pressing in a contact state.
